(19) United States
(12) Patent Application Publication
(10) Pub. No.: US 2026/0126350 A1
(43) Pub. Date: May 7, 2026

(54) EXTRACTION APPARARTUS AND METHOD FOR EXTRACTING

(71) Applicants: David J. Goodin, Yerington, NV (US); Douglas C. Dodd, San Jose, CA (US); Stephen M. Walters, Yerington, NV (US)

(72) Inventors: David J. Goodin, Yerington, NV (US); Douglas C. Dodd, San Jose, CA (US); Stephen M. Walters, Yerington, NV (US)

(21) Appl. No.: 18/934,646

(22) Filed: Nov. 1, 2024

(51) Int. Cl. G01N 1/08

(52) U.S. Cl. CPC G01N 1/08

(57) ABSTRACT

An extraction device includes a bell having a hollow interior cavity. The bell is configured to extend downwardly into a receptacle that receives and retains one or more beads. A probe is retained within the bell and configured for reciprocal motion to extend into and retract out of the receptacle. A head of the probe is connected to a stem of the probe such that a diameter of the head is greater than a diameter of the stem. A rim of the head circumferentially surrounds a junction with the stem and defines an interior surface of the head facing into the interior cavity of the bell. The probe is configured for extending into the receptacle to enable the beads to rest upon the rim, and for retracting to withdraw the beads upward into the hollow cavity of the bell, for extracting the bell and the beads from the receptacle.

### CROSS-REFERENCE TO RELATED APPLICATIONS

### I. BACKGROUND

### A. Technical Field

This invention pertains to the field of extraction and transference of objects from vessels having a narrow opening. In particular, the invention pertains to the extraction and transference of beads from wells, particularly for use with medical applications.

### B. Description of Related Art

In the field of cancer research, blood is processed to isolate and harvest cancer cells. These cancer cells are then used in various studies for developing drugs and treatment options. In one process, glass beads having a diameter of 2 mm (millimeters) are coated with a specific antigen that functions as “Cellular Velcro.” The coated beads are retained in a well and immersed in a sample of blood including cancer cells that have a certain protein that interlocks with the antigen. In this manner, the beads become coated with the cancer cells. The antigen only adheres to the cancer cells but does not adhere to any of the other blood constituents.

After the immersion and coating steps, the coated beads are removed from the well and transferred into a different well where they are washed to remove all of the blood constituents except for the cancer cells adhered to the beads. This process is repeated four times where the beads are transferred to wells to ensure thorough washing of the beads. Afterwards, the beads are transferred to another well including a release buffer which causes the cancer cells to release into solution, whereupon they are harvested and used for the studies.

The wells are typically cylindrical vessels or receptacles of about 6 mm in diameter, open at the top, and contain about 400 micrometers of fluid. In the prior art, the beads are removed manually by a technician, using a pair of tweezers to grab each bead separately. This is a slow, inefficient, time consuming and labor intensive method, prone to human error. It can be difficult for even an experienced technician to reach and grab beads through such a narrow opening, requiring multiple attempts for each bead. A bead can become lost or contaminated if dropped. So much handling can result in the beads becoming scuffed, rubbing the coating off the surface of the beads.

### II. SUMMARY

Provided in this disclosure is an extraction device and method with particular applicability for extracting beads or other spherical objects from a well or other receptacle.

The extraction device can be a bead picker including an outer bead picker tip having a proximal end and a distal end with a cap is at the proximal end for connecting to a support housing and a body having a central bore. The body defines a bell at the distal end and the central bore includes a hollow interior cavity of the bell. The outer bead picker tip is configured to extend the bell downwardly into a receptacle that receives and retains one or more beads. An inner bead picker tip is retained within the central bore of the outer bead picker tip. The inner bead picker tip includes a probe retained within the bell and configured for reciprocal motion to extend into and retract out of the receptacle. A head of the probe is connected to a stem of the probe in such a manner that a diameter of the head is greater than a diameter of the stem. A rim of the head circumferentially surrounds a junction with the stem and defines an interior surface of the head facing into the interior cavity of the bell. An electromagnetically actuated solenoid is retained within the support housing and connected to the inner bead picker tip probe for effecting the reciprocal motion of the inner bead picker tip. The solenoid is configured to selectively extend the probe into the receptacle to enable the beads to rest upon the rim, and to subsequently retract the probe and the beads upward into the interior cavity of the bell, for extracting the bell and the beads from the receptacle.

In further aspects, the body of the outer bead picker is cylindrical and has an outer diameter sized to fit within a diameter of a cylindrical receptacle. The head of the probe is generally conical and the rim is configured to have a curved profile corresponding to a shape of the beads, to facilitate resting of the beads on the rim. Three beads are provided in a circumferential configuration around the stem. The inner diameter of the bell is sized to receive and accommodate a width of the three beads in the circumferential configuration.

In another aspect, the present extraction device includes a bell having a hollow interior cavity. The bell is configured to extend downwardly into a receptacle that receives and retains one or more beads. A probe is retained within the bell and configured for reciprocal motion to extend into and retract out of the receptacle. A head of the probe is connected to a stem of the probe such that a diameter of the head is greater than a diameter of the stem. A rim of the head circumferentially surrounds a junction with the stem and defines an interior surface of the head facing into the interior cavity of the bell. The probe is configured to extend into the receptacle to enable the one or more one beads to rest upon the rim. The probe is configured for retracting to withdraw the beads upward into the hollow cavity of the bell, for extracting the bell and the beads from the receptacle.

In another aspect, the bell is a component of an outer bead picker tip and the probe is a component of an inner bead picker tip. The inner bead picker tip is received and retained within the outer bead picker tip. The outer bead picker tip includes a cap having an aperture for connecting to a support housing, and a body including the bell in such a manner that the interior cavity includes a central bore with an axis for coaxially receiving and retaining the inner bead picker tip. The body of the outer bead picker is cylindrical and has an outer diameter sized to fit within a diameter of a cylindrical receptacle.

In other aspects, the extraction device includes an electromagnetically actuated solenoid connected to the probe for effecting the reciprocal motion of selectively extending and retracting the probe. The head of the probe is generally conical and the rim is configured to have a curved profile corresponding to a shape of the beads, to facilitate resting of the beads on the rim. The one or more beads can include three beads arranged in a circumferential configuration around the stem. The inner diameter of the bell is sized to receive and accommodate a width of the three beads in the circumferential configuration.

In an additional aspect, a method of extracting beads includes steps of providing a receptacle retaining one or more beads and downwardly extending a bell having a hollow interior cavity into the receptacle proximal to the beads. A probe is extended outwardly from within the bell into the receptacle, alongside the beads, so that the beads rest atop an interior surface of the probe. The bell is extended further into the receptacle to encircle the beads. The probe is retracted to withdraw the beads upward into the hollow cavity of the bell. The bell, the probe, and the beads are then extracted from the receptacle.

In other further aspects, the method includes steps of downwardly extending the bell, the probe, and the beads into a different receptacle, and extending the probe outwardly from the bell into the different receptacle to release the beads and thereby deposit the beads into the different receptacle. Further steps can include washing the beads or extracting a predetermined material from an exterior surface of the beads while in the different receptacle. Three beads in a circumferential configuration around the probe can be retracted into the bell having an inner diameter sized to receive and accommodate a width of the three beads in the circumferential configuration.

In yet further aspects, the probe includes a head connected to a stem such that a diameter of the head is greater than a diameter of the stem. A rim of the head circumferentially surrounds a junction with the stem, and the rim includes the interior surface of the head facing into the interior cavity of the bell. The steps of extending and retracting the probe are performed using an electromagnetically actuated solenoid connected to the probe for effecting reciprocal motion of the probe.

According to an aspect, the present invention provides an automated process for picking and extracting beads or other cylindrical objects from a well or other receptacle,

According to another aspect, the present invention improves speed, accuracy and efficiency over the prior art manual process.

According to yet another aspect, the present invention reduces human error and resulting risks of contamination in handling of beads.

According to a further aspect, the present invention reduces handling and thereby improves the harvesting of cells from the beads.

Other benefits and advantages of this invention will become apparent to those skilled in the art to which it pertains upon reading and understanding of the following detailed specification.

### III. BRIEF DESCRIPTION OF THE DRAWINGS

The disclosed bead picker may take physical form in certain parts and arrangement of parts, embodiments of which will be described in detail in this specification and illustrated in the accompanying drawings which form a part hereof and wherein:

FIG. 1 is an exploded view of components of a bead picker in accordance with the present invention.

FIG. 2 is a side view of assembled components of a bead picker in accordance with the present invention.

FIG. 3 is a side sectional view of an outer bead picker in accordance with the present invention.

FIG. 4 is an exploded view of components of the bead picker including a housing in accordance with the present invention.

FIG. 5 is an assembled view of components of the bead picker including a housing in accordance with the present invention.

FIG. 6 is a perspective view showing the operation of the bead picker in accordance with the present invention.

FIG. 7 is a side view of the outer bead picker with the probe retracted in accordance with the present invention.

FIG. 8 is a side view of the outer bead picker with the probe extended in accordance with the present invention.

FIG. 9 is a perspective view of the outer bead picker with the probe extended in accordance with the present invention.

FIGS. 10A, 10B, and 10C are side sectional views of the bead picker in operation in accordance with the present invention.

### IV. DETAILED DESCRIPTION

Reference is now made to the drawings wherein the showings are for purposes of illustrating embodiments of the article only and not for purposes of limiting the same, and wherein like reference numerals are understood to refer to like components.

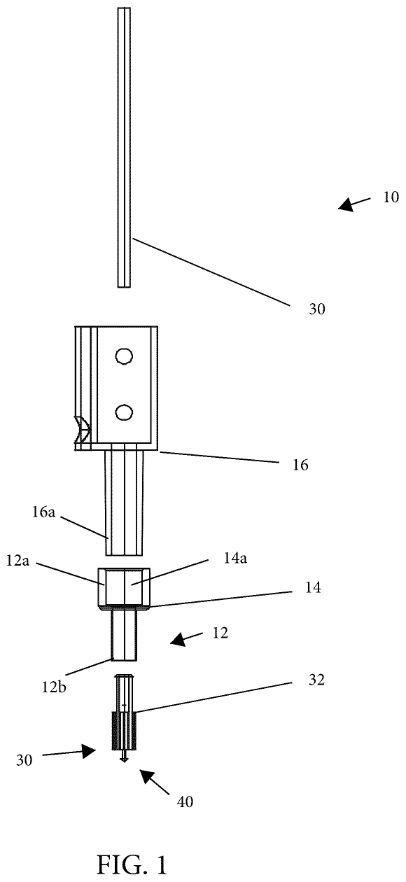

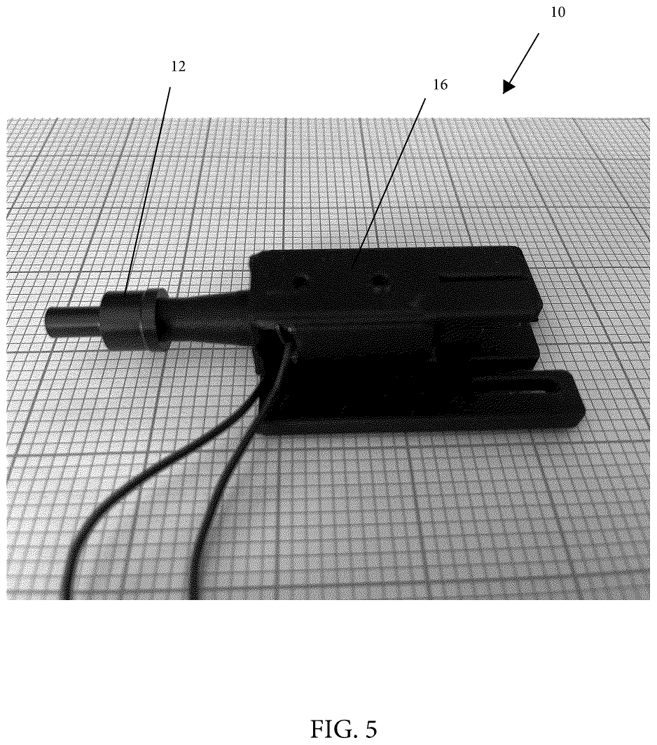

With specific reference to FIGS. 1, 5, and 6, a bead picker 10 is shown as an extraction device for removing beads from a well. However, it is to be understood that the present invention could be scaled in size to extract any sort of “beads” which are understood to be any spherical or other suitably shaped objects of any size that are received and retained in any suitable sort of receptacle, in accordance with the description herein.

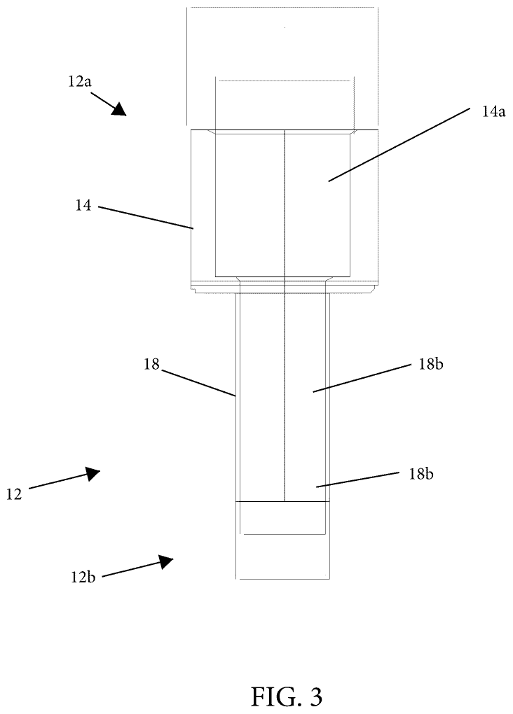

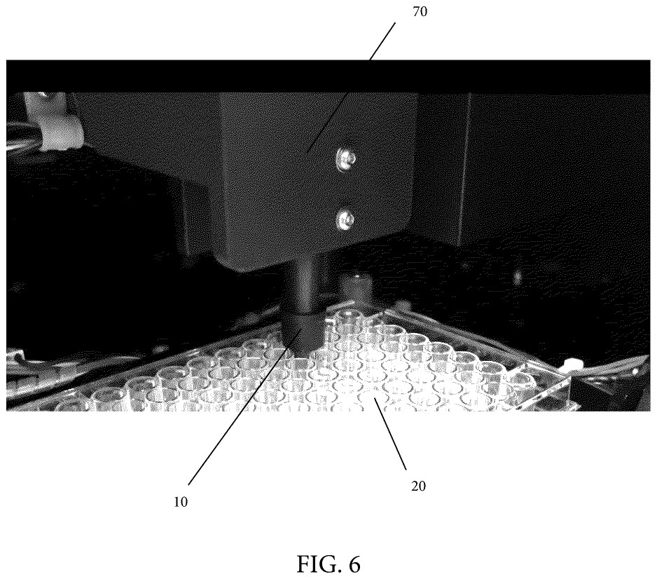

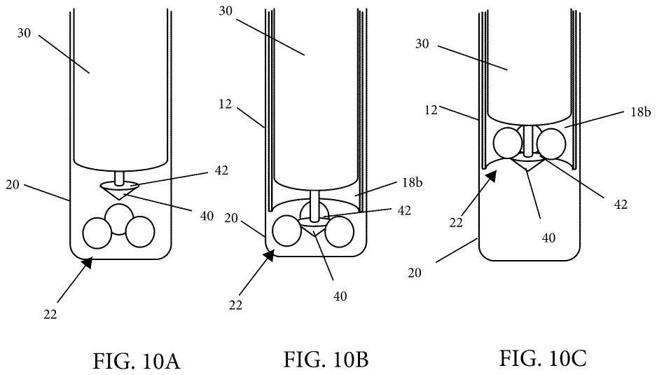

With ongoing specific reference to FIGS. 1, 3, 5, and 6, the bead picker 10 includes an outer bead picker tip 12 having a proximal end 12a located in a rearward portion, and a distal end 12b in a frontward portion, toward the operation of the device. A cap 14 is at the proximal end 12b of the outer bead picker tip 12 for connecting to a support housing 16. As best shown in FIG. 3, the cap 14 includes a cylindrical aperture 14a having an inner diameter sized to be matingly received over a cylindrical outer diameter 16a of the support housing 16. The outer bead picker tip 12 also includes a body 18 having a central bore 18a internally within the body 18. The distal end 12b of the body 18 defines a bell 18b. The central bore 18a includes a hollow cavity that defines the interior of the bell 18b. It is a “bell” insofar as it is a downwardly directed opening or cavity in a manner similar to an original “diving bell.” As shown in FIGS. 6, 10A, 10B, and 10C, the outer bead picker tip 12 is configured to extend the bell 18a downwardly into a well 20 or other such receptacle that receives and retains one or more beads 22. The outer diameter of the bell 18b is preferably generally cylindrical sized to be matingly received within the cylindrical inner diameter of the well 20.

With specific reference to FIGS. 1, 2, and 4, an inner bead picker tip 30 is retained within the central bore 18a of the outer bead picker tip. The inner bead picker tip 30 includes a middle portion 32 having a diameter sized to be matingly received within the inner diameter of the central bore 18a. In this manner the inner bead picker tip 30 is configured to freely slide back and forth with reciprocal movement within the central bore 18a. An upper portion 34 of the inner bead picker tip 30 has a narrower outer diameter than the middle portion 32 and is sized to be received within an inner diameter 16b of the housing 16. In this manner, the reciprocal movement of the inner bead picker tip 30 is restricted by the middle portion 32 which stops upon encountering the narrower inner diameter 16b of the support housing 16. The upper portion 34 also has an internal bore 34a having an inner diameter sized to engage with a connecting rod 30, which runs through the support housing 16, the outer bead picker tip 12 and into the upper portion of the inner bead picker tip 30 along a central axis 36. The connecting rod 36 is configured for the reciprocal movement to displace the inner bead picker tip 30 as described hereinbelow.

With reference to FIGS. 1, 2, 4,6, 8, 9, 10A, 10B, and 10C, the inner bead picker tip 30 includes a probe 40 retained within the bell 18b and configured for the reciprocal motion to extend into and retract out of the well 20. A head 42 of the probe 40 is connected to a stem 44 of the probe 40 in such a manner that a diameter of the head is greater than a diameter of the stem 44. A rim 46 of the head 42 circumferentially surrounds a junction of the head 42 and stem 44. The rim 46 defines an interior surface of the head 42 that faces upwards into the interior cavity of the bell 28b.

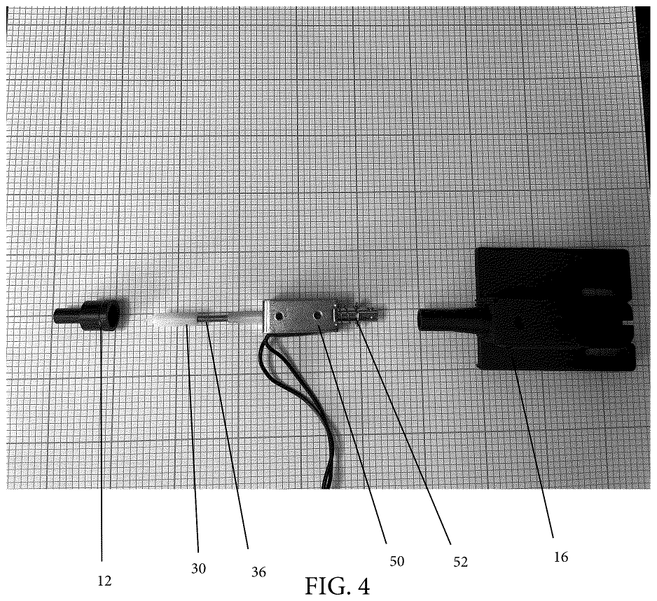

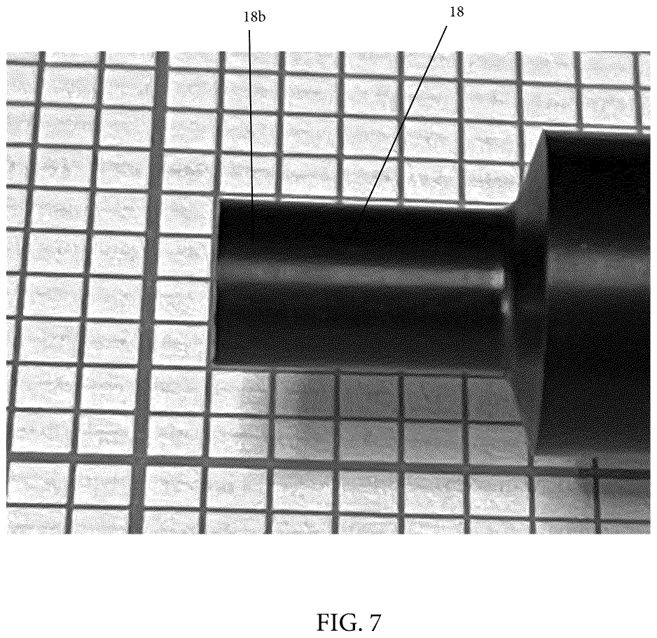

With specific reference to FIGS. 1 and 4, an electromagnetically actuated solenoid 50 is retained within the support housing 16 and is connected to the inner bead picker tip 30, and thus is also connected to the probe 40. The solenoid 50 is alternately energized to thereby effect the reciprocal motion of the inner bead picker tip 30. A spring 52 restores the probe 40 to the original position. As depicted in FIGS. 7, 8, 9, 10A, and 10B, the solenoid 50 is thus configured to selectively extend the probe 40 into the well 20 to enable the beads 20 to rest upon the rim 46, and to subsequently retract the probe 40 and the beads 22 (FIG. 10C) upward into the interior cavity of the bell 18b, for extracting the bell 18, the probe 40, and the beads 22 from the well 20. It is contemplated that the probe 40 can be retracted when the solenoid 50 is not energized and extended when the solenoid 50 is energized. Alternatively, the probe 40 can be extended when the solenoid 50 is not energized and retracted when the solenoid 50 is energized.

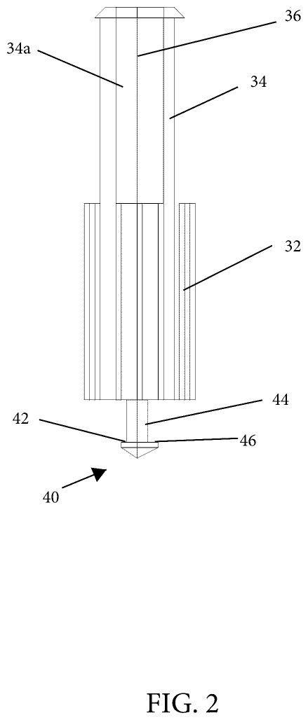

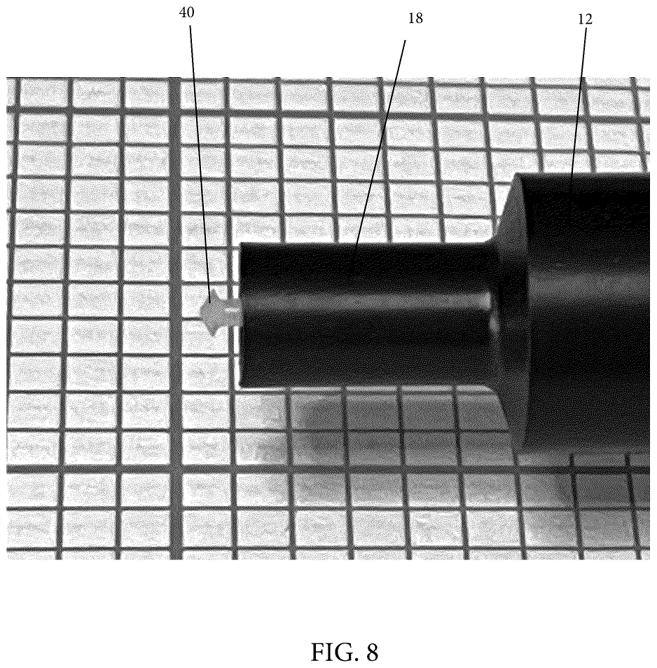

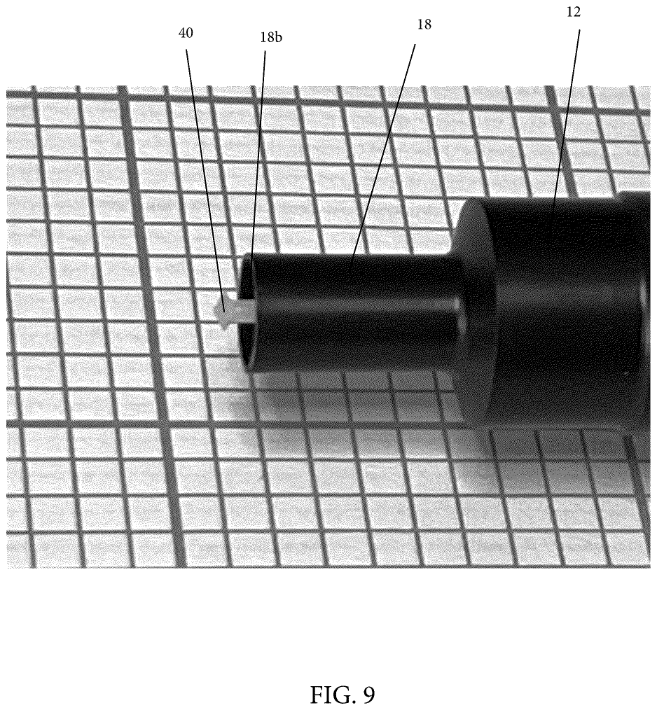

As evident from FIGS. 1, 2, 8, and 9, the head 42 of the probe 40 is preferably “top-shaped,” generally conical. As shown in FIGS. 1 and 2 the rim 46 is configured to be flat, as a type of shelf. As shown in FIGS. 8 and 9, the rim 46 can be configured to have a curved profile corresponding to a shape of the beads 22, to facilitate resting of the beads 22 on the rim 46. As shown in FIGS. 10A, 10B, and 10C, three beads 22 are provided in a circumferential configuration around the stem 42. The inner diameter of the bell 18b is sized to receive and accommodate the width of the three beads 22 having 2 mm diameters in the circumferential configuration as shown. It is to be appreciated that any size sphere can be picked up by suitably by adjusting the inner diameter of the bell 18b.

With further reference to FIGS. 1, 2, 8, and 9, in a preferred embodiment, the cylindrical diameter of the hollow interior of the bell 18b is about 5 mm. The conical head 42 of the probe 40 is preferably about 2 mm in diameter with a height of about 1 mm. The stem 44 has a diameter of about 1 mm. In this manner, the 2 mm beads fit within the interior of the bell 18b. When the probe 40 is retracted, the 2 mm bottom of the conical head 42 allows an annular gap of about 1.5 mm which is too small to permit the beads 22 to drop down therebetween. In this manner, the beads 22 are securely retained during extraction from one well 20 and deposition into another well 22. It is to be appreciated that the size of the bead picker 10 can be scaled up and down in size to extract beads 22 (or other suitable objects) without departing from the invention.

With ongoing reference to FIGS. 1, 2, 8, and 9, the 1 mm height of the conical head 42 is half the height of the 2 mm beads. In this manner, the conical head 42 pushes beads 22 out of the way when the probe 42 is extended, thereby clearing a path but for the probe 40. The 1 mm height is still low enough to allow the beads 22 to roll back onto the rim 46. The bell 18b with the entire outer bead picker top 12 cylinder comes down forcing the beads 22 back toward the stem 46 in the center as they are captured inside the bell 18b. The probe 40 is then retracted and the beads 22 are contained within the bell 18b. In this manner, the present bead picker 10 picks up all three beads at once.

With additional reference to FIGS. 1, 2, 8, and 9, the angle of conical head 42 is a shallow angle such that the rim 46 is no more than half the annular gap, or 0.75 mm. The height of the head 42 is short so that the beads 22 are forced over the edge of the rim 46 during extension of the probe 40. The angle thereby causes the beads 22 to move away. The bell 18b comes down and thereby forces the beads 22 back toward the center. The head 42 is not taller than half the height of the diameter of the beads 22 to enable the beads 22 to roll onto the rim 46. The vertical travel of the probe 40 during extension is about 2.10 mm, slightly larger than the 2 mm diameter of the beads 22 so that the beads 22 have adequate clearance to enter the bell 18b.

As shown in FIG. 6, the present bead picker 10 is preferably used with an actuator 70 which moves the bead picker 10 with an X-Y movement so that beads 22 can be extracted from one well 20 and displaced by precise predetermined amount to be deposited into a different well 20, in order to implement the steps of washing and release as described hereinabove. The X-Y movement of the actuator 70 enables the bead picker 10 to hit the center of the well 20 each time. In this manner, the bead picker 10 can be used with wells of varying diameters, still maintaining high accuracy. The present bead picker 10 thereby removes the human error associated with prior art practices, and improves accuracy.

Having described the bead picker apparatus, a method of extracting beads is now described with reference to FIGS. 6, 10A, 10B, and 10C. A well 20 or other such receptacle is provided retaining one or more beads 22. A bell 18b having a hollow interior cavity is downwardly extended into the receptacle 20 proximal to the beads 22. A probe 40 is extended outwardly from within the bell 18b into the receptacle 20, alongside the beads 22, so that the beads 22 rest atop a rim 46, which is an interior surface of the probe 40. Bell 18b comes down onto the beads 22 while the probe 40 is retracted to withdraw the bead 22 upward into the hollow cavity of the bell 18b. The bell 18b, the probe 40, and the beads 22 are then extracted from the receptacle 20.

With further reference to FIGS. 6, 10A, 10B, and 10C, a step is performed of downwardly extending the bell 18b, the probe 40, and the beads 22 into a different receptacle 20. The probe 40 is extended outwardly from the bell 18b into the different receptacle 20 to release the beads 22 and thereby deposit the beads 22 into the different receptacle 20. Additional steps can include washing the beads 22 or extracting a predetermined material such as the aforementioned cancer cells from the exterior surface of the beads 22 while in the different receptacle 20. Three beads 22 placed in a circumferential configuration around the probe 40 can be retracted into the bell 18b which has an inner diameter sized to receive and accommodate the width of the three beads 22 in the circumferential configuration.

With additional reference to FIGS. 6, 10A, 10B, and 10C, the probe 40 includes a head 42 connected to a stem 44 such that a diameter of the head 42 is greater than a diameter of the stem 44. A rim 46 of the head 42 circumferentially surrounds a junction with the stem 44, and the rim 46 includes the interior surface of the head 42 facing into the interior cavity of the bell 18b. The steps of extending and retracting the probe are performed using an electromagnetically actuated solenoid 50 connected to the probe 40 for effecting reciprocal motion of the probe 40.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. An extraction device, comprising:
a bell having a hollow interior cavity, wherein the bell is configured to extend downwardly into a receptacle that receives and retains at least one bead;
a probe retained within the bell and configured for reciprocal motion to extend into and retract out of the receptacle;
a head of the probe connected to a stem of the probe such that a diameter of the head is greater than a diameter of the stem;
a rim of the head circumferentially surrounding a junction with the stem and defining an interior surface of the head facing into the interior cavity of the bell;
wherein the probe is configured for extending into the receptacle to enable the at least one bead to rest upon the rim; and
wherein the probe is configured for retracting to withdraw the at least one bead upward into the interior cavity of the bell, for extracting the bell and the at least one bead from the receptacle.

2. The extraction device of claim 1, wherein the bell is a component of an outer bead picker tip and the probe is a component of an inner bead picker tip.

3. The extraction device of claim 2, wherein the inner bead picker tip is received and retained within the outer bead picker tip.

4. The extraction device of claim 3, wherein the outer bead picker tip comprises a cap having an aperture for connecting to a support housing, and a body comprising the bell such that the interior cavity comprises a central bore with an axis for coaxially receiving and retaining the inner bead picker tip.

5. The extraction device of claim 4, wherein the body of the outer bead picker is cylindrical having an outer diameter sized to fit within a diameter of a cylindrical receptacle.

6. The extraction device of claim 1, further comprising an electromagnetically actuated solenoid connected to the probe for effecting the reciprocal motion of selectively extending and retracting the probe.

7. The extraction device of claim 1, wherein the head of the probe is generally conical and wherein the rim is configured to have a curved profile corresponding to a shape of the at least one bead, to facilitate resting of the at least one bead on the rim.

8. The extraction device of claim 1, wherein the at least one bead comprises three beads in a circumferential configuration around the stem, wherein an inner diameter of the bell is sized to receive and accommodate a width of the three beads in the circumferential configuration.

9. A bead picker, comprising:
an outer bead picker tip having a proximal end and a distal end, further comprising a cap at the proximal end for connecting to a support housing and a body having a central bore, wherein the body defines a bell at the distal end and the central bore comprises a hollow interior cavity of the bell, wherein the outer bead picker tip is configured to extend the bell downwardly into a receptacle that receives and retains at least one bead;
an inner bead picker tip retained within the central bore of the outer bead picker tip, wherein the inner bead picker tip comprises a probe retained within the bell and configured for reciprocal motion to extend into and retract out of the receptacle;
a head of the probe connected to a stem of the probe such that a diameter of the head is greater than a diameter of the stem;
a rim of the head circumferentially surrounding a junction with the stem and defining an interior surface of the head facing into the interior cavity of the bell; and
an electromagnetically actuated solenoid retained within the support housing and connected to the inner bead picker tip probe for effecting the reciprocal motion of the inner bead picker tip;
wherein the solenoid is configured to selectively extend the probe into the receptacle to enable the at least one bead to rest upon the rim, and to subsequently retract the probe and the at least one bead upward into the interior cavity of the bell, for extracting the bell and the at least one bead from the receptacle.

10. The bead picker of claim 9, wherein the body of the outer bead picker is cylindrical having an outer diameter sized to fit within a diameter of a cylindrical receptacle.

11. The bead picker of claim 9, wherein the head of the probe is generally conical and wherein the rim is configured to have a curved profile corresponding to a shape of the at least one bead, to facilitate resting of the at least one bead on the rim.

12. The bead picker of claim 9, wherein the at least one bead comprises three beads in a circumferential configuration around the stem, wherein an inner diameter of the bell is sized to receive and accommodate a width of the three beads in the circumferential configuration.

13. A method of extracting beads, comprising steps of:
providing a receptacle retaining at least one bead;
downwardly extending a bell having a hollow interior cavity into the receptacle proximal to the at least one bead;
extending a probe outwardly from within the bell into the receptacle, alongside the at least one bead, so that the at least one bead rests atop an interior surface of the probe;
extending the bell further into the receptacle to encircle the at least one bead;
retracting the probe to withdraw the at least one bead upward into the hollow cavity of the bell; and
extracting the bell, the probe, and the at least one bead from the receptacle.

14. The method of claim 13, further comprising steps of downwardly extending the bell, the probe, and the at least one bead into a different receptacle, and extending the probe outwardly from the bell into the different receptacle to release the at least one bead and thereby depositing the at least one bead into the different receptacle.

15. The method of claim 14, further comprising a step of washing the at least one bead or extracting a predetermined material from an exterior surface of the at least one bead while in the different receptacle.

16. The method of claim 13, further comprising retracting three beads in a circumferential configuration around the probe into the bell having an inner diameter sized to receive and accommodate a width of the three beads in the circumferential configuration.

17. The method of claim 13, wherein the probe comprises a head connected to a stem such that a diameter of the head is greater than a diameter of the stem, and wherein a rim of the head circumferentially surrounds a junction with the stem, wherein the rim comprises the interior surface of the head facing into the interior cavity of the bell.

18. The method of claim 13, wherein the steps of extending and retracting the probe are performed using an electromagnetically actuated solenoid connected to the probe for effecting reciprocal motion of the probe.
